(19) United States
(12) Patent Application Publication
(10) Pub. No.: US 2015/0232731 A1
(43) Pub. Date: Aug. 20, 2015

(54) Hybrid-Filled Epoxy Molding Compositions

(71) Applicant: UT-Battelle, LLC, Oak Ridge, TN (US)

(72) Inventor: Andrew A. Wereszczak, Oak Ridge, TN (US)

(21) Appl. No.: 14/180,633

(22) Filed: Feb. 14, 2014

(51) Int. Cl. C09K 5/14

(52) U.S. Cl. CPC C09K 5/14

(57) ABSTRACT

A hybrid-filled, electrically insulating composition includes a resinous matrix comprising 56 to 65 volume percent of the total composition and a particulate dispersed phase comprising essentially the balance of the total composition. The dispersed phase includes a first ceramic component such as AlN, BN, or BeO and a second ceramic component such as MgO, Al₂O₃, SiO₂, a polycrystalline alumino-silicate, and/or a metal. The dispersed phase makes up more than 50 volume percent of the first component. The molding composition has a thermal conductivity of at least 3.5 W/mK.

### STATEMENT REGARDING FEDERALLY SPONSORED RESEARCH

The United States Government has rights in this invention pursuant to contract no. DE-AC05-000R22725 between the United States Department of Energy and UT-Battelle, LLC.

### BACKGROUND OF THE INVENTION

The Office of Vehicle Technology Program's Advanced Power Electronics and Electric Motors (APEEM) program has expressed emphasis on cost-reducing research targets, challenges, and areas. These include high-temperature components, packaging, and reliability for long-term transformation technologies, and thermal management technologies to reduce volume and enhance thermal reliability. The goals of this project are to develop, characterize, and test candidate organic or epoxy molding compounds (EMCs) that are thermally conductive and that have the potential to be low-cost, volume reducing, and better-performing alternatives to presently used compounds for applications such as, for example, dielectrics (i.e., high breakdown voltage) in power electronic devices, potting compounds used with capacitors, potting compounds used in motors, and the like. The term “compound” as used herein means a protective insulating and sealing composition used to embed and/or encapsulate at least one electrical component; the term is commonly used in the art to which the invention pertains.

With respect to dielectric applications, “better performing” represents a higher-temperature capability and the sustainment of dielectric character at high voltages and gel-like mechanical damping properties under thermal cycling and vibratory conditions. For better performing potting compounds for both capacitors and motors, interest exists to identify alternatives that have improved thermal conductivity or enhance the thermal conductivity of an existing potting compound. It is also desirable to achieve improved structural performance, improved damping performance, and the like without compromising thermal performance of the compound.

Table 1. shows thermal conductivity values for bulk, fully dense materials of some compositions of interest.

TABLE 1

| | | | | | Coefficient |
|---|---|---|---|---|---|
| | Electrical | Bulk Thermal | Heat | | of Thermal |
| | Resistivity | Conductivity k | Capacity | Density | Expansion |
| | (Ω · cm) at | (W/m · K) | Cp | ρ | CTE |
| Material | 25° C. | at 25° C. | (J/kg · K) | (kg/m³) | (×10⁻⁶/° C.) |
| SiO₂ | >10¹⁴ | 2 | 700 | 2600 | 0.5 |
| Al₂O₃ | >10¹⁴ | 30 | 900 | 3900 | 8 |
| BN | >10¹⁴ | 275* | 1600 | 1900 | 1-12* |
| MgO | >10¹⁴ | 40 | 900 | 3600 | 10 |
| SiC | >10² | 120 | 800 | 3100 | 4 |
| AlN | >10¹⁴ | 250 | 700 | 3200 | 5 |
| BeO | >10¹⁴ | 280 | 600 | 2900 | 9 |
| Epoxy | >10¹² | 0.05-0.4 | 1500 | 1200 | 30-60 |

*Anisotropy

Bulk, fully dense materials generally exhibit highest achievable thermal conductivity values. Once such materials are ground into powder and incorporated into a matrix having a very low thermal conductivity, the ability of exploit those high values rapidly diminishes, as seen in the data for EMC thermal conductivity.

Unfortunately, the most thermally-conductive candidates have certain disadvantages. For example, BeO is toxic, AlN and BN are prohibitively expensive, and SiC can suscept (i.e., self-heat) in an electric or magnetic field, making it unsuitable for application in potting compositions.

MgO and Al₂O₃ have lower thermal conductivity, but are useful in some applications. Al₂O₃ is hard and abrasive imparting wear on molds and other EMC processing equipment. MgO is slightly more thermally conductive, costs about the same, and is softer and less abrasive than Al₂O₃ and is therefore a more attractive material for use in EMC production.

A good source of background information relating to the fabrication and performance of epoxy molding compounds can be found in Andrew A. Wereszczak, et al., Thermally Conductive MgO-Filled Epoxy Molding Compounds, IEEE Transactions on Components, Packaging and Manufacturing Technology, Vol. 3, No. 12, December 2013.

There is a need for lower-cost and better-performing epoxy molding compositions for dielectric and thermal management applications in, for example, power electronics, LED lighting, and electric motors.

### BRIEF SUMMARY OF THE INVENTION

In accordance with one aspect of the present invention, the foregoing and other objects are achieved by a hybrid-filled, electrically insulating composition includes a resinous matrix comprising 56 to 65 volume percent of the total composition and a particulate dispersed phase comprising essentially the balance of the total composition. The dispersed phase includes a first ceramic component such as AlN, BN, or BeO and a second ceramic component such as MgO, Al₂O₃, SiO₂, a polycrystalline alumino-silicate, and/or a metal. The dispersed phase makes up more than 50 volume percent of the first component. The molding composition has a thermal conductivity of at least 3.5 W/mK.

### DETAILED DESCRIPTION OF THE INVENTION

At least two different filler materials having preselected particle size distributions and volume fractions are combined with an electrically insulating, organic, preferably resinous matrix to produce a hybrid thermally conductive epoxy molding compound (hereinafter referred to as a hybrid-filled composite) that can be suitable for various applications. A first, relatively high cost filler material having high thermal conductivity is combined with second, relatively lower cost filler material having lower thermal conductivity in order to reduce the overall cost of the hybrid composite while maintaining sufficient performance characteristics for suitability to a particular application. It was found that specific ranges of volume fractions and particle size distributions of first and second filler materials, described hereinbelow, resulted in unpredictably satisfactory performance.

A hybrid composite in accordance with the present invention is comprised of three material components as represented by equations (1) and (2):

V_{C}=V_{M}+V_{F1}+V_{F2} (1)

V_{F1}>V_{F2} (2)

where V_{C}, V_{M}, V_{F1} and V_{F2} are, respectively the volumes of the hybrid-filled composite (C), the continuous organic matrix (M), the dispersed first filler material (F1), and the dispersed second filler material (F2).

A matrix material M occupies 40-80 volume percent, preferably 45-75 volume percent, more preferably 50-70 volume percent of the total hybrid-filled composition as a continuous phase in the hybrid-filled composite. M can include, for example: epoxy, polyvinyl, polyurethane, polyamide, polyester, polyester-polyimide, polyamide-polyimide, polyaryletherketone, polyphenylene sulfide, fluoropolymer, silicone, paraffin such as paraffin wax, or a combination of any of the foregoing.

A first, relatively high cost filler material F1, occupies 10-50 volume percent, preferably 15-45 volume percent, more preferably 20-40 volume percent of the total composition. F1 is a relatively highly thermally conductive ceramic component of the dispersed phase (filler), and can include, for example AlN, BN, BeO, and combinations of any of the foregoing. F1 is dielectric and insusceptible to alternating electric or magnetic fields. It should be noted that BeO is considered to be toxic.

A second, relatively lower cost filler material F2, a relatively less thermally conductive ceramic component of the dispersed phase, occupies essentially the balance of the total hybrid-filled composition. F2 can include, for example, MgO, Al₂O₃, SiO₂, (crystalline and/or amorphous form), a polycrystalline alumino-silicate (for example, mullite and/or 3Al₂O₃.2SiO₂), ZnO, and combinations of any of the foregoing. F2 is dielectric, essentially insusceptible to alternating electric or magnetic fields and preferably has a modest thermal conductivity. The inexpensiveness of F2 lessens the cost of the hybrid-filled composition while its lower thermal conductivity does not significantly impede the bulk thermal conductivity of the hybrid-filled composite because its volume fraction and particle size are smaller than those of F1.

F2 may also include a metallic filler in some applications. While metallic fillers can have high thermal conductivity, and the hybrid-filled composition can still be electrically insulative at low voltages because of the continuous organic phase, hybrid-filled compositions with metallic fillers will not generally have a sufficiently high breakdown voltage for high-voltage applications. High breakdown voltage is a sought-after characteristic in hybrid-filled compositions used as EMCs; therefore, ceramic (electrically insulative) fillers are considered to be more desirable for high-voltage applications.

The first and/or second filler material can treated chemically to promote adhesion and/or bonding between fillers and the matrix material. Such treatment is important for achieving thermal transfer across material interfaces between particles and matrix. Filler particles can be chemically treated by silanization, which involves coating the surface with a silanizing agent such as, for example, glycidoxypropyltrimethoxysilane.

Particle size distributions can generally be described in terms of d0 (smallest particle size), d50 (median particle size), and d100 (largest particle size). Bimodal particle size distribution of the F1 and F2 materials is important in order to achieve optimal thermal conductivity of the hybrid-filled composition. Bimodal relationships in size distributions are represented by equations (3), (4), and (5):

$$\begin{matrix}d {0}_{F 2} > 1 µm & ( 3 ) \\ \frac{d {100}_{F 1} - d {0}_{F 1}}{d {100}_{F 2} - d {0}_{F 2}} = 4 to 12 & ( 4 ) \\ \frac{d {50}_{F 1}}{d {50}_{F 2}} = 4 to 12 & ( 5 )\end{matrix}$$

Referring to equation (3), particles smaller than 1 μm are considered unsuitable for effective thermal transfer. Equations (3) and (4) set forth the operable limits of the bimodal system. In a preferred system, the relationships are as follows:

$$\begin{matrix}\frac{d {100}_{F 1} - d {0}_{F 1}}{d {100}_{F 2} - d {0}_{F 2}} = 5 to 10 & ( 6 ) \\ \frac{d {50}_{F 1}}{d {50}_{F 2}} = 5 to 10 & ( 7 )\end{matrix}$$

More efficient exploitation of the thermal conductivity of F1 will occur if its particle sizes are relatively large in order to promote larger contact area between adjacent F1 particles and thermal (phonon) transfer in the final, fully processed hybrid-filled composition. The d100 of F1 is the largest particle in the hybrid-filled composition, and its maximum size can be limited at least by dimensions, geometry, and strength requirements of an article made using the composition. For example, a particle larger than the smallest cross-section of an article would not be suitable for use therein.

As illustrated in the examples shown below, a larger volume fraction of the more thermally-conductive F1 filler material creates a greater number of those needed, large contact areas resulting in better overall bulk thermal conductivity of the hybrid-filled composition. The F1 filler material is relatively expensive, and given that thermal transfer is not as efficient in smaller-sized particles (largely independent of the material thermal conductivity), it becomes logical to use the F2 for the smaller of the two particle size distributions in the bimodal particle size distribution blend.

For each of F1 and F2, the range of the particle size distribution should be as narrow as is reasonably achievable; difference between d100 and d0 should be as small as practical. Ideally, F1 and F2 would each be mono-sized, but that is difficult to achieve in practice.

An essentially equiaxed particle shape for each the F1 and F2 fillers is preferred in order to promote predictable, homogeneous, and isotropic mixing and inter-particle packing. Such packing of equiaxed particles will in turn enable the achievement of maximum thermal conductivity of the entire hybrid-filled composition. The ideal particle shape is spherical.

Essentially non-equiaxed particle shapes such as platelet and acicular forms for example, can be problematic because they tend to inhibit efficient mixing and particle packing. Non-equiaxed particles can be undesirably aligned under shear stresses that are inherently produced in injection molding or other force-induced processes, causing inhomogeneity in the hybrid-filled composition. It is contemplated that such inhomogeneity could undesirably establish unpredictable and uncontrolled anisotropy in thermal conductivity. Therefore, the closer to equiaxed or spherical, the better the particle shape.

An ideal embodiment of the invention, achieving the greatest possible thermal conductivity of the hybrid-filled composition, would be for F1 and F2 to be composed of mono-sized spherical particles in relative volumes and particle size ratio such that the spheres of F2 have a best-fit in the interstices of the F1 spheres, as illustrated in equations (8), (9), and (10):

$$\begin{matrix}d {100}_{F 1} = d {50}_{F 1} = d {0}_{F 1} & ( 8 ) \\ d {100}_{F 2} = d {50}_{F 2} = d {0}_{F 2} & ( 9 ) \\ \frac{d {50}_{F 1}}{d {50}_{F 2}} = 7 & ( 10 )\end{matrix}$$

The skilled artisan will recognize that the ideal hybrid system may possibly be more costly than a non-hybrid system using only F1 particles in the matrix. Therefore, a trade-off exists with respect to quality and cost of the essentially equiaxed particles.

Depending on the factors described above, the hybrid-filled molding composition can have a thermal conductivity of at least 3.5 W/mK, at least 4 W/mK, or at least 4.5 W/mK.

The skilled artisan will further recognize that the compositions described herein can made using as a standard method such as that described in Wereszczak, et al., which is referenced hereinabove.

### Example I

A hybrid-filled composition was made by the method described in Wereszczak, et al., which is referenced hereinabove. The matrix material M comprised a conventional thermoset material: bisphenol-A polymer resin and a phenolic hardener. The first filler material F1 comprised essentially spherical BN having a particle size distribution of about: d0=4 μm, d50=63 μm, d100=176 μm. The second filler material F2 comprised essentially spherical MgO having a particle size distribution of about: d0=3 μm, d50=11 μm, d100=124 μm. Volume percent of the components was 57.0 V_{M}, 36.4 V_{F1}, and 6.6 V_{F2}. Bulk thermal conductivity of the hybrid-filled composition was tested and found to be 4.9 W/mK.

### Example II

A hybrid-filled composition was made in accordance with Example I, with the exception that volume percent of the components was 54.7 V_{M}, 29.3 V_{F1}, and 16.0 V_{F2}. Bulk thermal conductivity of the hybrid-filled composition was tested and found to be 4.0 W/mK.

### Example III

A hybrid-filled composition was made in accordance with Example I, with the exception that volume percent of the components was 54.9 V_{M}, 7.6 V_{F1}, and 37.5 V_{F2}. Bulk thermal conductivity of the hybrid-filled composition was tested and found to be 2.0 W/mK.

While there has been shown and described what are at present considered to be examples of the invention, it will be obvious to those skilled in the art that various changes and modifications can be prepared therein without departing from the scope of the inventions defined by the appended claims.

What is claimed is:

1. A hybrid-filled, electrically insulating composition comprising:
a. a resinous matrix comprising 56 to 65 volume percent of the total composition; and
b. a particulate dispersed phase comprising essentially the balance of the total composition, the dispersed phase comprising:
i. a first ceramic component comprising at least one material selected from the group consisting of AlN, BN, and BeO; and
ii a second ceramic component comprising at least one material selected from the group consisting of MgO, Al₂O₃, SiO₂, a polycrystalline alumino-silicate, and a metal,
said dispersed phase comprising more than 50% of said first component, and said molding composition having a thermal conductivity of at least 3.5 W/mK.

2. A composition in accordance with claim 1 wherein said second ceramic component comprises at least one material selected from the group consisting of MgO, Al₂O₃, SiO₂, and a polycrystalline alumino-silicate.

3. A composition in accordance with claim 1 wherein said resinous matrix comprises at least one resin selected from the group consisting of epoxy, polyvinyl, polyurethane, polyamide, polyester, polyester-polyimide, polyamide-polyimide, polyaryletherketones, polyphenylene sulfides, and fluoropolymers.

4. A composition in accordance with claim 1 wherein said second ceramic component has an average particle size distribution wherein d0=<1 μm.

5. A composition in accordance with claim 1 wherein said particulate dispersed phase has a bimodal particle size distribution of said first ceramic component and said second ceramic component, expressed as:
$$\frac{d {100}_{F 1} - d {0}_{F 1}}{d {100}_{F 2} - d {0}_{F 2}} = 4 to 12.$$

6. A composition in accordance with claim 5 wherein
$$\frac{d {100}_{F 1} - d {0}_{F 1}}{d {100}_{F 2} - d {0}_{F 2}} = 5 to 10.$$

7. A composition in accordance with claim 1 wherein said particulate dispersed phase has a bimodal particle size distribution of said first ceramic component and said second ceramic component, expressed as:
$$\frac{d {50}_{F 1}}{d {50}_{F 2}} = 4 to 12.$$

8. A composition in accordance with claim 7 wherein
$$\frac{d {50}_{F 1}}{d {50}_{F 2}} = 5 to 10.$$

9. A composition in accordance with claim 1 wherein said first ceramic component comprises essentially equiaxed particles.

10. A composition in accordance with claim 1 wherein said second ceramic component comprises essentially equiaxed particles.

11. A composition in accordance with claim 1 wherein said molding composition has a thermal conductivity of at least 4.0 W/mK.

12. A composition in accordance with claim 11 wherein said molding composition has a thermal conductivity of at least 4.5 W/mK.
